(19) United States
(12) Patent Application Publication
(10) Pub. No.: US 2025/0328896 A1
(43) Pub. Date: Oct. 23, 2025

(54) SYSTEM AND METHOD FOR ORCHESTRATION OF MOBILE EXCHANGE UTILIZING DECENTRALIZED NON-FUNGIBLE TOKEN IDENTIFICATION AND SECURE NEAR-FIELD COMMUNICATION

(71) Applicant: BANK OF AMERICA CORPORATION, Charlotte, NC (US)

(72) Inventors: Debraj Goswami, Hyderabad (IN); Priyanka Krishnankutty Cheerath, Chennai (IN); Deepak Suresh Dhokane, Maharashtra (IN); Ritesh Ramesh Mehta, Mumbai (IN); Badal Jayaswal, Mumbai (IN)

(73) Assignee: BANK OF AMERICA CORPORATION, Charlotte, NC (US)

(21) Appl. No.: 18/642,387

(22) Filed: Apr. 22, 2024

(51) Int. Cl. G06Q 20/38

(52) U.S. Cl. CPC G06Q 20/3829; G06Q 20/38215

(57) ABSTRACT

Systems, computer program products, and methods are described herein for the orchestration of mobile exchange utilizing decentralized non-fungible token identification and secure near-field communication. The invention enables a device to manage a series of operations including receiving transaction requests via a customer application, activating a teller selection algorithm, and generating necessary notifications for transaction management. The system handles secure exchanges of physical funds through near-field communication, reinforced by the generation of unique transaction IDs and public keys for enhanced security. Additionally, all transaction details are meticulously recorded on a distributed ledger, ensuring the integrity and traceability of each transaction.

### TECHNOLOGICAL FIELD

Example embodiments of the present disclosure relate to orchestration of mobile exchange utilizing decentralized non-fungible token identification and secure near-field communication.

### BACKGROUND

The advent of digital technology has fundamentally transformed transactions, increasingly steering them towards mobile and digital platforms. However, this shift has not come without its challenges, particularly in the realm of mobile exchanges. Traditional banking systems and automated teller machines (ATMs) have been the backbone of cash transactions for decades, yet they face numerous limitations in accessibility, reliability, and convenience, especially in urgent situations. Furthermore, the rise of peer-to-peer (P2P) payment systems has facilitated digital transactions but still falls short in addressing immediate cash needs in various scenarios. These challenges highlight a growing demand for innovative solutions that can provide immediate, secure, and convenient access to cash without the dependency on physical banking infrastructures or conventional digital payment methods alone.

Applicant has identified a number of deficiencies and problems associated with orchestration of mobile exchange utilizing decentralized non-fungible token identification and secure near-field communication. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for orchestration of mobile exchange utilizing decentralized non-fungible token identification and secure near-field communication. (NFC). The disclosed system introduces a novel approach to facilitate immediate cash transactions between individuals, leveraging the security and transparency of distributed ledger technology and the convenience of NFC for authentication and transaction completion.

The system comprises a mobile application, referred to as the fellow teller system, that enables users in need of cash (receivers) to connect with other users (tellers) who are willing and able to provide cash. Through the use of distributed ledger systems, transactions are created and identified by unique NFTs, ensuring security and traceability without compromising privacy. A unique selection algorithm is employed to match tellers with receivers, based on transaction size and proximity, facilitated by NFC-NFT powered authentication. This approach not only circumvents the limitations of traditional ATM-based cash withdrawals but also introduces a decentralized, user-centric model for cash exchanges, offering 24/7 availability, identity protection, and transaction integrity.

As such, embodiments of the invention relate to systems, methods, and computer program products for orchestration of mobile exchange utilizing decentralized non-fungible token identification and secure near-field communication, the invention including the general steps of: receiving a transaction request for a transaction via a customer application, the transaction request comprising an amount of physical funds needed and one or more criteria for selecting a teller; activating a teller selection algorithm to sort one or more teller options retrieved from a teller database based on the transaction request to identify one or more suitable tellers; generating and transmitting a notification to the one or more suitable tellers via a teller application, wherein the notification includes a subset of transaction details; receiving an acceptance from at least one of the one or more suitable tellers, triggering a generation of a unique transaction identification (ID) and a public key; facilitating a secure exchange of physical funds using near-field communication based on the generated public key; and recording transaction details on a distributed ledger to finalize the transaction and update non-fungible token ownership.

In some embodiments, the invention further includes the step of encrypting the transaction details using the public key before transmitting the details to the distributed ledger.

In some embodiments, exchange of physical funds is confirmed via both the customer application and the teller application.

In some embodiments, the teller selection algorithm further comprises assigning weights to each of the one or more criteria for selecting a teller, the criteria including at least one of proximity to a customer, an availability of the requested amount of physical funds, and operational hours of the tellers.

In some embodiments, the transaction request further includes a preferred transaction time, and the teller selection algorithm prioritizes tellers who are available during the specified transaction time.

In some embodiments, the invention further includes a step of validating the digital identity of the teller and a customer using digital signatures prior to exchange of physical funds.

In some embodiments, the generated public key is part of a public and private key pair, and a private key is used to decrypt received communications during the transaction process.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for orchestration of mobile exchange utilizing decentralized non-fungible token identification and secure near-field communication, in accordance with an embodiment of the disclosure;

FIGS. 2A-2B illustrate an exemplary process of creating an NFT 200, in accordance with an embodiment of the invention;

FIG. 3 illustrates components of an exemplary transaction initiation process 300 for orchestration of mobile exchange utilizing decentralized non-fungible token identification and secure near-field communication, in accordance with an embodiment of the disclosure;

FIG. 4 illustrates components of an exemplary user registration process 400 for orchestration of mobile exchange utilizing decentralized non-fungible token identification and secure near-field communication, in accordance with an embodiment of the disclosure;

FIG. 5 illustrates components of an exemplary transaction completion and reconciliation process 500 for orchestration of mobile exchange utilizing decentralized non-fungible token identification and secure near-field communication, in accordance with an embodiment of the disclosure;

FIG. 6 illustrates components of an exemplary NFT generation process 600 for orchestration of mobile exchange utilizing decentralized non-fungible token identification and secure near-field communication, in accordance with an embodiment of the disclosure;

FIG. 7 illustrates components of an exemplary dual teller process 700 for orchestration of mobile exchange utilizing decentralized non-fungible token identification and secure near-field communication, in accordance with an embodiment of the disclosure; and

FIG. 8 illustrates a process flow 800 for orchestration of mobile exchange utilizing decentralized non-fungible token identification and secure near-field communication, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository—a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

The technology underpinning the present invention integrates decentralized non-fungible token (NFT) identification with secure near-field communication (NFC) to facilitate mobile exchanges of cash between individuals. The system utilizes distributed ledger technology to ensure the security and uniqueness of each transaction, supported by NFTs that uniquely represent transaction identities. Customers requiring immediate tangible funds face numerous potential challenges: unawareness of a nearest ATM, absence of nearby ATMs, non-functional nearby ATMs, ATMs out of funds, and the need for cash transactions during travel or at locations without nearby facilities. Existing solutions are predominantly digital and do not offer flexibility for immediate physical fund transactions.

The present invention simplifies a process of obtaining physical funds when and where needed without relying on ATMs. By using a novel mobile application, a customer can connect with a nearby “teller,” or other user whom has volunteered to assist, that can provide physical funds in return for a guaranteed securitization of their peer to peer loan. The system uses digital tokens, representing secure and unique transaction identification numbers (IDs), to manage transactions without revealing personal information or exact locations, utilizing a user device NFC capabilities for secure communications.

Accordingly, the present disclosure introduces a novel system and method for orchestrating physical fund exchanges via mobile platforms that use encrypted, distributed ledger-based tokens for transaction security and identity verification, coupled with NFC for secure communication. This system provides a reliable alternative to traditional ATMs by enabling users to locate and transact with nearby tellers, enhancing the accessibility of cash and reducing dependency on entity-owned machines.

What is more, the present disclosure provides a technical solution to a technical problem. As described herein, the technical problem includes the lack of immediate access to physical funds and the reliance on functional, stocked ATMs or entity branches. The technical solution presented herein allows for an innovative way to facilitate physical fund transactions using distributed ledger technology to generate secure NFTs that represent transaction identities, coupled with NFC for secure data exchange. In particular, this system is an improvement over existing ATM-dependent solutions by reducing the number of steps needed to access physical funds, streamlining the process, enhancing transaction security by preventing malfeasance and ensuring transaction authenticity, and eliminating the need for physical entity infrastructure for physical fund withdrawals, thus saving on computing and network resources. Furthermore, the technical solution described herein uses a rigorous, computerized process to perform specific tasks and/or activities that were not previously performed, such as the direct pairing of individuals for transactions without third-party intermediation or location tracking, thus conserving computing resources and enhancing user data security.

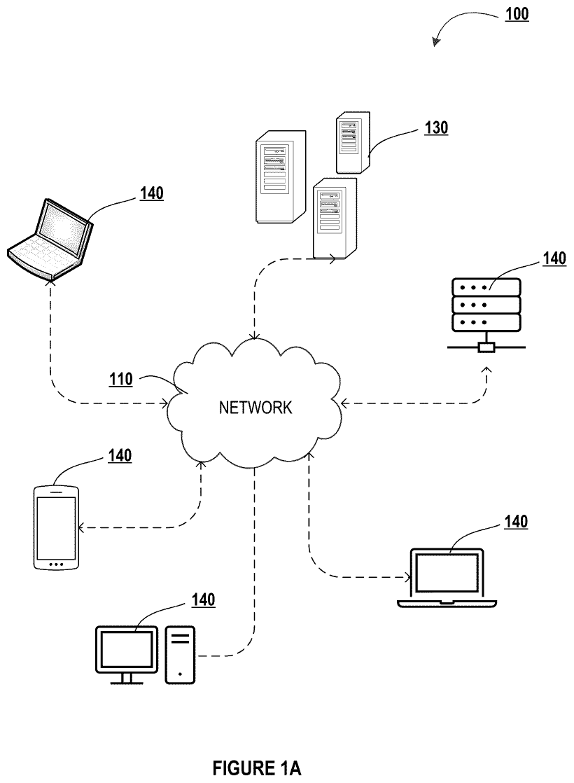

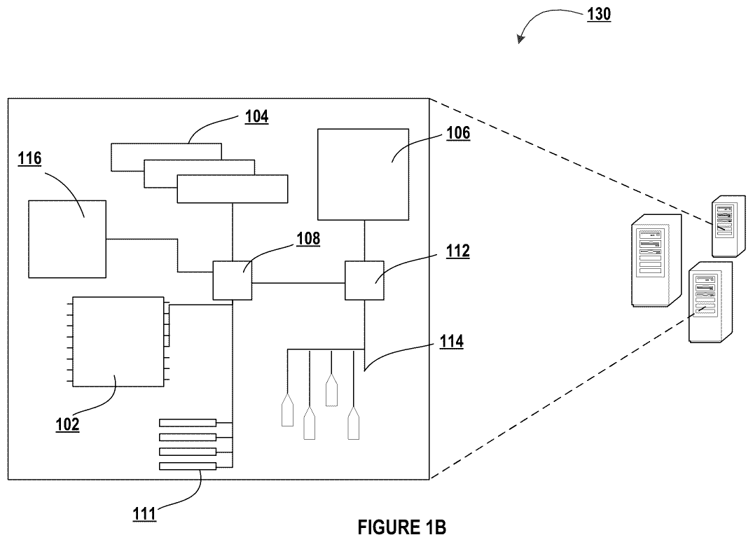

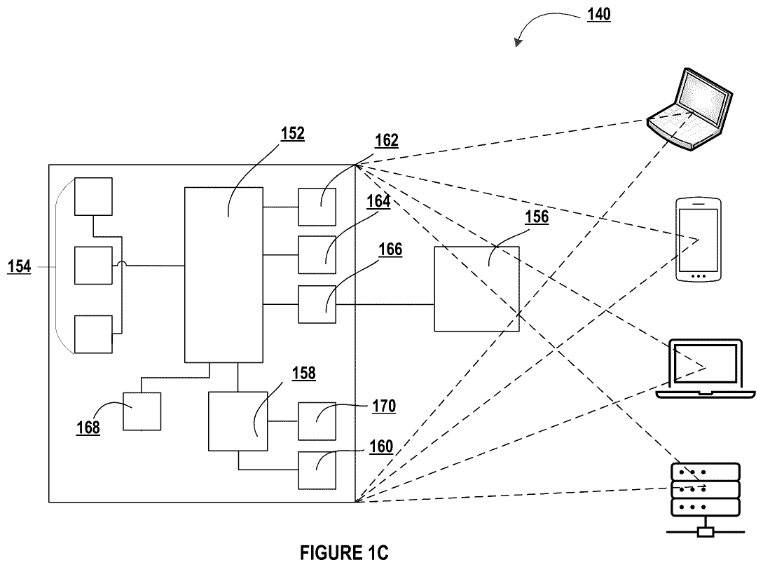

FIGS. 1A-1C illustrate technical components of an exemplary distributed computing environment 100 for orchestration of mobile exchange utilizing decentralized non-fungible token identification and secure near-field communication, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

An NFT is a cryptographic record (referred to as “tokens”) linked to a resource. An NFT is typically stored on a distributed ledger that certifies ownership and authenticity of the resource, and exchangeable in a peer-to-peer network.

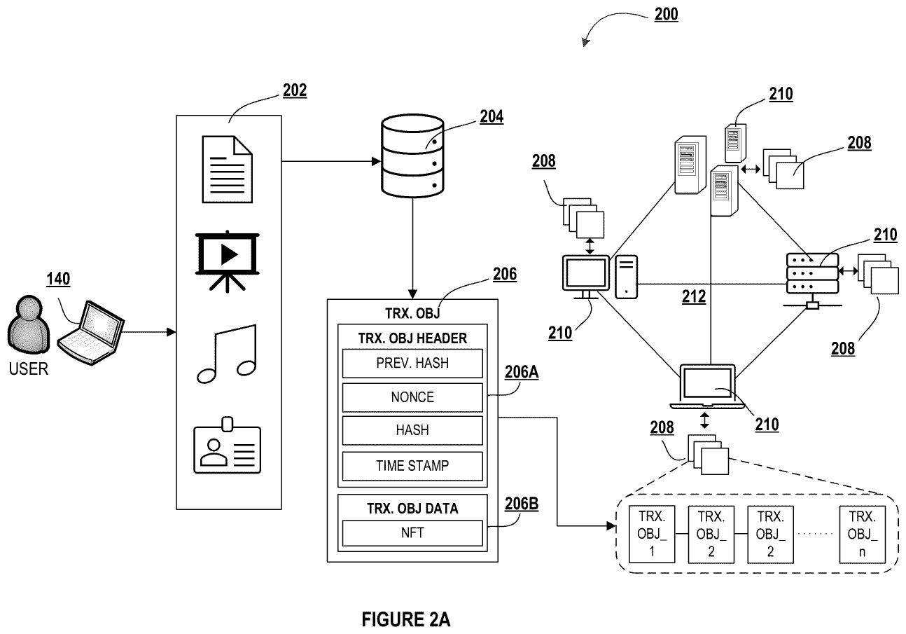

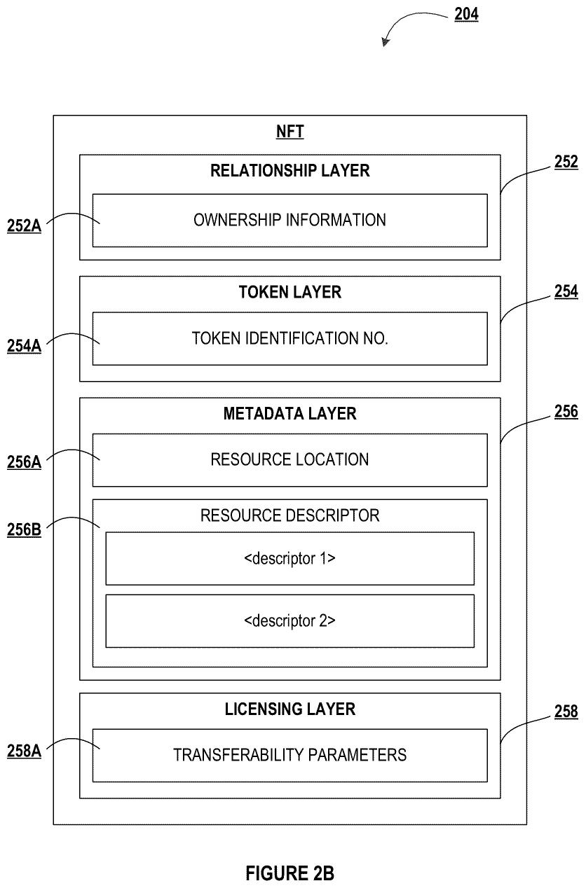

FIG. 2A illustrates an exemplary process of creating an NFT 200, in accordance with an embodiment of the invention. As shown in FIG. 2A, to create or “mint” an NFT, a user (e.g., NFT owner) may identify, using a user input device 140, resources 202 that the user wishes to mint as an NFT. Typically, NFTs are minted from digital objects that represent both tangible and intangible objects. These resources 202 may include a piece of art, music, collectible, virtual world items, videos, real-world items such as artwork and real estate, or any other presumed valuable object. These resources 202 are then digitized into a proper format to produce an NFT 204. The NFT 204 may be a multi-layered documentation that identifies the resources 202 but also evidences various transaction conditions associated therewith, as described in more detail with respect to FIG. 2A.

To record the NFT in a distributed ledger, a transaction object 206 for the NFT 204 is created. The transaction object 206 may include a transaction header 206A and a transaction object data 206B. The transaction header 206A may include a cryptographic hash of the previous transaction object, a nonce—a randomly generated 32-bit whole number when the transaction object is created, cryptographic hash of the current transaction object wedded to the nonce, and a time stamp. The transaction object data 206B may include the NFT 204 being recorded. Once the transaction object 206 is generated, the NFT 204 is considered signed and forever tied to its nonce and hash. The transaction object 206 is then deployed in the distributed ledger 208. At this time, a distributed ledger address is generated for the transaction object 206, i.e., an indication of where it is located on the distributed ledger 208 and captured for recording purposes. Once deployed, the NFT 204 is linked permanently to its hash and the distributed ledger 208, and is considered recorded in the distributed ledger 208, thus concluding the minting process.

As shown in FIG. 2A, the distributed ledger 208 may be maintained on multiple devices (nodes) 210 that are authorized to keep track of the distributed ledger 208. For example, these nodes 210 may be computing devices such as system 130 and end-point device(s) 140. One node 210 may have a complete or partial copy of the entire distributed ledger 208 or set of transactions and/or transaction objects on the distributed ledger 208. Transactions, such as the creation and recordation of a NFT, are initiated at a node and communicated to the various nodes. Any of the nodes can validate a transaction, record the transaction to its copy of the distributed ledger, and/or broadcast the transaction, its validation (in the form of a transaction object) and/or other data to other nodes.

FIG. 2B illustrates an exemplary NFT 204 as a multi-layered documentation of a resource, in accordance with an embodiment of an invention. As shown in FIG. 2B, the NFT may include at least relationship layer 252, a token layer 254, a metadata layer 256, and a licensing layer 258. The relationship layer 252 may include ownership information 252A, including a map of various users that are associated with the resource and/or the NFT 204, and their relationship to one another. For example, if the NFT 204 is purchased by buyer B1 from a seller S1, the relationship between B1 and S1 as a buyer-seller is recorded in the relationship layer 252. In another example, if the NFT 204 is owned by O1 and the resource itself is stored in a storage facility by storage provider SP1, then the relationship between O1 and SP1 as owner-file storage provider is recorded in the relationship layer 252. The token layer 254 may include a token identification number 254A that is used to identify the NFT 204. The metadata layer 256 may include at least a file location 256A and a file descriptor 256B. The file location 256A may provide information associated with the specific location of the resource 202. Depending on the conditions listed in the smart contract underlying the distributed ledger 208, the resource 202 may be stored on-chain, i.e., directly on the distributed ledger 208 along with the NFT 204, or off-chain, i.e., in an external storage location. The file location 256A identifies where the resource 202 is stored. The file descriptor 256B may include specific information associated with the source itself 202. For example, the file descriptor 256B may include information about the supply, authenticity, lineage, provenance of the resource 202. The licensing layer 258 may include any transferability parameters 258B associated with the NFT 204, such as restrictions and licensing rules associated with purchase, sale, and any other types of transfer of the resource 202 and/or the NFT 204 from one person to another. Those skilled in the art will appreciate that various additional layers and combinations of layers can be configured as needed without departing from the scope and spirit of the invention.

In the context of the present invention, the NFT 204 operates as a digital passport for physical funds transfers, encapsulating all pertinent details that permit, validate, and record the transaction within a secure, immutable structure. The ownership information in the relationship layer 252 not only establishes the current holder of the NFT but also retains a transactional history, delineating a clear lineage of physical fund ownership transfers. This history is critical in proving the legitimacy of the physical funds, especially in scenarios where the origin of the funds is scrutinized for compliance with financial regulations. The token identification number within the token layer 254 serves as a unique fingerprint for the NFT, facilitating quick identification and verification across the distributed ledger system. This unique identifier is crucial for integrating the NFT within the broader financial ecosystem, ensuring that the physical funds represented by the NFT can be seamlessly tracked and authenticated without exposing the physical location of the funds or the personal information of the individuals involved.

Furthermore, the metadata layer 256 goes beyond simple identification; it provides a narrative for the physical funds, detailing their qualitative and quantitative aspects. This may include the condition of the funds, their denominations, and other details pertinent to the parties involved in the transaction. Such transparency ensures that all parties have a clear understanding of the funds in question, which is essential for maintaining trust in a system where physical verification is not always possible. Meanwhile, the licensing layer 258 dictates the terms of engagement, functioning as a rulebook for the circulation of the NFT within the system. It defines the parameters within which the NFT, and by extension the physical funds it represents, can be transferred, split, or amalgamated, providing a robust framework for transactions that is designed to prevent malfeasance and unauthorized transfers. This layer ensures that the system can function smoothly by outlining the rights and responsibilities associated with the NFT, creating a secure and orderly environment for the exchange of physical funds.

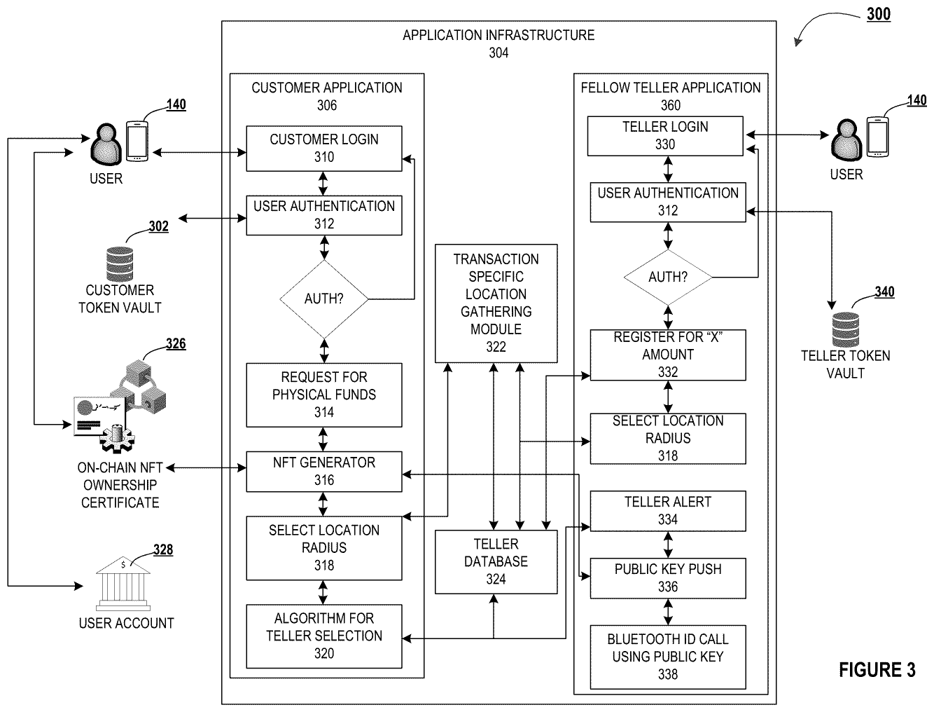

FIG. 3 illustrates components of an exemplary transaction initiation process 300 for orchestration of mobile exchange utilizing decentralized non-fungible token identification and secure near-field communication, in accordance with an embodiment of the disclosure. As depicted in FIG. 3, the process begins with a user 140 who interacts with a customer application 306. The customer application 306 includes a customer login 310 component that facilitates user access control. Following successful access, user authentication 312 verifies the identity of the user 140, ensuring secure access to the mobile application, which may comprise a customer application 306 component and a fellow teller application 360 component.

Upon authentication, the user 140 may initiate a request for physical funds 314 through the customer application 306. The NFT generator 316 is then engaged to create an on-chain NFT 326 that serves as an ownership certificate for the transaction. This NFT is securely stored within the customer token vault 302, which maintains a repository of such tokens associated with the user 140.

Simultaneously, the process incorporates a fellow teller application 360 utilized by another user 140, who may act as a teller in the transaction. This application also includes a teller login 330 and a user authentication 312 component, ensuring that only authorized tellers are able to participate in the transaction system. Tellers registered in the system can specify the amount of physical funds they can provide by registering for “X” amount 332 and selecting a location radius 318 within which they are willing to operate. An algorithm for teller selection 320 is employed to determine the optimal teller from the teller database 324 based on the request parameters and the tellers' location and availability. This selection is facilitated by the transaction-specific location gathering module 322, which utilizes the location radius preferences set by the tellers to match them with user requests. The algorithm for teller selection 320 employs a sophisticated set of rules and parameters to ensure the optimal match between the user's request for physical funds and the available tellers. One embodiment of the algorithm may utilize a multi-factor scoring system that takes into account the proximity of tellers to the user's location, the amount of physical funds they have registered to provide, their transaction history including reliability scores, and their current status of availability.

To facilitate this, the transaction-specific location gathering module 322 first collects geolocation data from the tellers within the framework of user-defined privacy settings. This module may employ GPS coordinates, Wi-Fi triangulation, and cell tower signal strengths to obtain accurate location data with the tellers' consent. The collected location data is then processed to determine the proximity of each teller relative to the user's current location, taking into consideration the location radius preferences set by both the user and the tellers. The algorithm may also interface with the teller token vault 340 to ascertain the amount of physical funds available with each teller. It analyses the balance and history of transactions to predict the reliability of the tellers in fulfilling the request. Furthermore, it can assess the tellers' historical data for average response times and completion rates of transactions to determine their availability and reliability.

An embodiment of the teller selection algorithm might include a weighted scoring system where factors such as proximity, available funds, and teller reliability are assigned different weights based on their importance to the user's request. For instance, in situations where immediate transfer is crucial, proximity may be given a higher weight. Alternatively, for larger transactions, the availability of requisite funds and a high reliability score might be prioritized.

In the execution of the teller selection algorithm, a comprehensive assessment is conducted that intricately processes multiple data points for each teller in the database. The algorithm analyzes geolocation coordinates, which may include real-time or last known locations, to calculate each teller's distance from the user, thereby facilitating proximity-based matching. Concurrently, the algorithm evaluates the funds availability, examining the current balance and the maximum transaction limit each teller has established, to ensure the teller has requisite physical funds to fulfill the user's request.

The availability of tellers is another critical component considered by the algorithm, where the status of each teller is checked to determine whether they are actively looking to provide physical funds at the moment of the transaction. This status check ensures that users are matched with tellers who are ready and willing to engage in the transaction immediately. Additionally, the algorithm delves into the transaction history of the tellers, scrutinizing past records for completion rates, average transaction values, and user feedback scores. This historical analysis is pivotal for assessing the reliability and performance of tellers over time.

Furthermore, the algorithm takes into account the operational hours of each teller, or those specific times when tellers are typically active or have indicated their availability for transactions. This temporal data is essential to align the schedules of the user and the teller, thus augmenting the likelihood of a successful and timely exchange of physical funds. By aggregating and processing these varied data points, the algorithm for teller selection is able to perform a nuanced and dynamic match-making that is tailored to the user's specific needs and the operational capabilities of the tellers, ensuring a seamless and efficient transaction process.

The selection process can occur in several stages, starting with an initial filtering based on location and availability, followed by a more nuanced analysis of transaction history and available funds. Once potential tellers are identified, the algorithm may use predictive analytics to forecast the likelihood of a successful and timely transaction. The system can be designed to automatically update the user account 328 to reflect the selection and initiate the next steps in the transaction process. Moreover, this algorithm can be continually refined using machine learning techniques, where it learns from each transaction to improve its predictive accuracy and selection criteria, thus enhancing the overall efficiency and user satisfaction of the mobile exchange system.

For example, in some embodiments, the algorithm designed for selecting an optimal teller may incorporate a systematic approach to weighting various teller attributes to compute an overall teller score. This approach assigns relative importance to different criteria such as proximity to the user, the availability of physical funds, the teller's operational hours, their transaction history, and their current availability status. Each of these criteria is assigned a weight that reflects its significance in the selection process. To illustrate, one might consider proximity as 40% of the total score due to its importance in facilitating a quick exchange, whereas the availability of funds might be weighted at 30%, operational hours at 10%, transaction history at 10%, and the teller's current availability status also at 10%.

Using this weighted system, the algorithm calculates a composite score for each potential teller. Take Teller A as an instance: located 1 kilometer away from the user, which might typically correspond to a score of 60 out of 100, since the ideal distance for maximum scoring is within 500 meters. When adjusted for the assigned weight of 40%, Teller A's proximity contributes 24 points to their total score. Similarly, if Teller A is capable of providing 80% of the user's fund request, they receive an 80 out of 100 score for fund availability, which after weighting contributes another 24 points. In scenarios where Teller A is available during the user's requested time, they would score a perfect 100 for operational hours, which translates to 10 points when the corresponding weight is applied. Continuing with transaction history, a high reliability rating of 90 out of 100 would contribute an additional 9 points, and should Teller A be currently available to transact, this would result in another full 10 points added to their score for availability status.

Upon summing these weighted contributions, Teller A would amass a total score of 77 out of a possible 100 points. This composite score is then utilized by the system to rank Teller A alongside other potential tellers to determine the most suitable match for the user's transaction request. The computation of these scores could be implemented using backend development languages known for their robustness and capability in handling complex data operations, such as Python, Java, or C#. Particularly, Python may be favored due to its comprehensive mathematical and statistical libraries which are adept at performing such algorithmic calculations. These computations would typically be carried out within the backend infrastructure of the system, ensuring that the algorithm's processing is transparent to the user and that the integrity of the transaction process is maintained.

Once a teller is selected, a teller alert 334 is issued to notify the chosen teller of a pending transaction. The teller is then able to use a public key push 336 to securely communicate with the user's device. The transaction is finalized using a Bluetooth ID call using the public key 338, enabling secure communication between the user's and the teller's devices for the transfer of the NFT and the physical funds. The on-chain NFT 326 acts as a digital proof of the transaction, and the user account 328 is updated to reflect the transaction completion. This seamless process ensures that the exchange of physical funds is conducted in a secure, efficient, and user-friendly manner.

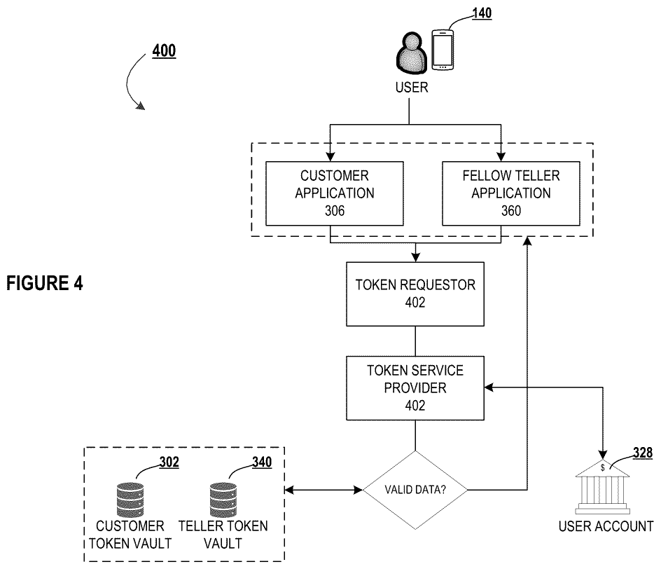

FIG. 4 illustrates components of an exemplary user registration process 400 for orchestration of mobile exchange utilizing decentralized non-fungible token identification and secure near-field communication, in accordance with an embodiment of the disclosure. The process begins when a user 140 interacts with the system through either the customer application 306 or the fellow teller application 360. These applications serve as gateways for the user and the potential tellers to access the various functionalities provided by the system. In some embodiments, the customer application 306 and the fellow teller application 360 are developed using secure coding practices, incorporating OAuth 2.0 for authorization, and are deployed on scalable cloud infrastructure to handle varying loads of user activity.

A token requestor 402 is a critical component that operates within both applications, serving as the initiator for creating or accessing digital tokens that represent either the user's request for physical funds or a teller's availability to provide funds. When a request is made through the token requestor 402, it communicates with the token service provider 402, which is responsible for the generation, validation, and management of tokens. The token service provider 402 ensures the integrity and security of token transactions, checking for valid data before proceeding with any transaction-related processes. In some embodiments, the token requestor 402 utilizes a combination of RESTful API calls and JSON Web Tokens (JWT) for secure messaging between the client applications and the token service provider 402. The user's and teller's interactions with the token service provider 402 are facilitated by their respective token vaults, the customer token vault 302 for users and the teller token vault 340 for tellers. These vaults are secure repositories for the tokens and play a pivotal role in maintaining the transaction history and token balances of the respective parties.

Once the token service provider 402 verifies the validity of the data in the transaction, it proceeds to interact with the user account 328. In some embodiments, this is executed through a distributed ledger technology, employing smart contracts for automating the updates to the user account 328 upon successful verification of the transaction conditions. The user account 328 is an essential component where the transaction details are recorded, and the balance of physical funds available for exchange is maintained. It is the ultimate ledger that reflects the outcome of the token exchange process, indicating the successful registration of the user or the teller in the mobile exchange system. In some embodiments, the distributed ledger is implemented on a distributed ledger platform, such as Ethereum or the like, and it operates in conjunction with off-chain storage solutions for scalability and cost efficiency. Additionally, to enhance transaction privacy and control, the system may incorporate a private distributed ledger or a layer 2 solution that sits atop the main distributed ledger to handle transactions more efficiently. It is understood that these private chains or layer 2 solutions can optimize transaction speed and reduce costs by processing transactions off the main chain while still maintaining the security and integrity afforded by the underlying distributed ledger technology. This hybrid approach ensures scalability and cost efficiency by leveraging off-chain storage solutions and on-chain verification, providing a balanced framework that can adapt to a range of transaction volumes and security requirements.

The process as detailed in FIG. 4 ensures that the registration and initiation of transactions within the system are conducted securely and efficiently, leveraging the robust architecture of decentralized non-fungible token identification to facilitate reliable mobile exchanges of physical funds. This registration process forms the foundation for a trusted exchange environment, enabling users to engage with tellers confidently, knowing that their transactions are backed by a system designed with security and transparency at its core.

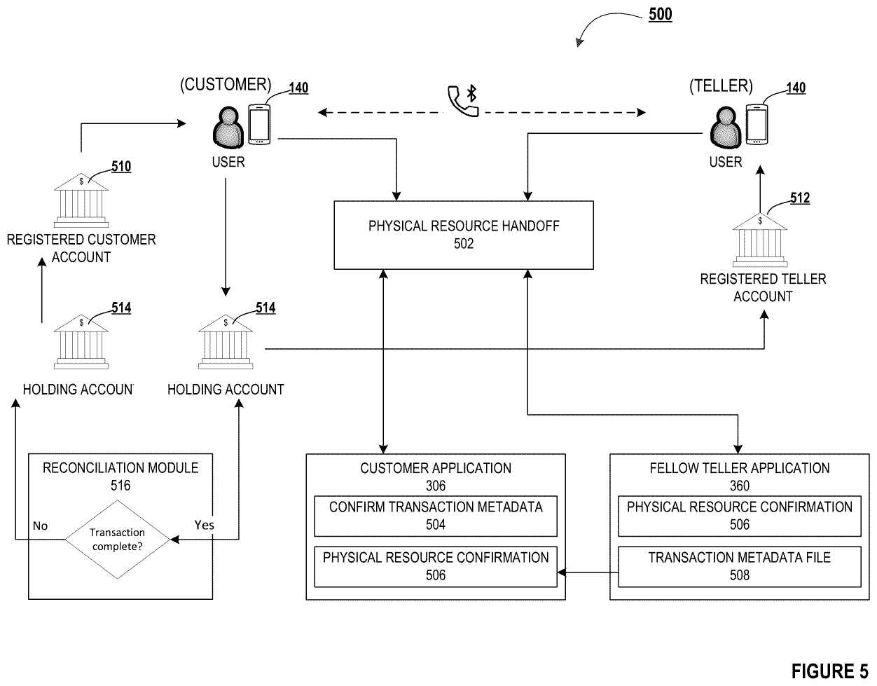

FIG. 5 illustrates components of an exemplary transaction completion and reconciliation process 500 for orchestration of mobile exchange utilizing decentralized non-fungible token identification and secure near-field communication, in accordance with an embodiment of the disclosure. This process delineates the steps taken from the physical handoff of resources to the finalization and confirmation of the transaction between the customer and the teller. In initiating this process, a secure session is established between the customer and teller devices, in some embodiments using SSL/TLS encryption protocols, ensuring that the physical resource handoff 502 is both private and secure.

The process initiates with a user 140, who is depicted as a customer, engaging in a physical resource handoff 502 with another user 140, acting as a teller. The customer application 306, which, in some embodiments, is built on a platform like Android or iOS, leverages NFC technology to facilitate the exchange, with the customer's device sending a digitally signed token that represents the physical funds to the teller's device. The physical exchange is facilitated and tracked through their respective applications: the customer application 306 for the customer and the fellow teller application 360 for the teller. Upon completion of the physical resource handoff 502, the customer uses their application 306 to confirm the transaction metadata 504, which includes details such as the amount of physical funds exchanged and the time of the transaction. In some embodiments, this metadata is encrypted and hashed, providing an additional layer of integrity to the transaction record.

Simultaneously, the teller confirms the receipt of physical funds through the fellow teller application 360, which processes the physical resource confirmation 506 and generates a transaction metadata file 508. In some embodiments, this step involves the application querying the device's NFC interface to record the transaction timestamp and secure the exchange details, which are then encapsulated in a distributed ledger compatible transaction format. The format for this encapsulation would typically be a JSON object or a similar data structure that adheres to the smart contract's expected inputs on the distributed ledger. The JSON object, for instance, would be structured to include fields for the sender's and receiver's wallet addresses, the transaction amount, a timestamp in UNIX epoch time, and a unique transaction identifier. For instance, in preferred embodiments, the application on the device may use a built-in NFC reader API to capture the transaction data, which typically includes the transaction amount, timestamp, and a unique identifier for the exchange. This file contains comprehensive details of the transaction and is essential for maintaining a transparent and verifiable record of the exchange. Both the registered customer account 510 and the registered teller account 512 play a pivotal role in the transaction. A JSON object may be serialized and signed using the sender's private key to ensure non-repudiation and integrity of the data. The serialized transaction payload is transmitted over a secure, encrypted channel to the distributed ledger system, where it is queued for validation and recording onto the ledger. Smart contracts on the distributed ledger system, written in a language such as Solidity for Ethereum-based platforms, process this incoming data. These are the financial repositories that reflect the change in balance resulting from the transaction. A holding account 514 temporarily houses the funds during the transaction, ensuring that they are securely in escrow until all parts of the transaction are verified. In some embodiments, smart contracts on the distributed ledger automate the escrow and release of funds, which are only completed upon the fulfillment of the coded contract conditions. Once recorded, the transaction is immutable and timestamped, providing a trustworthy and transparent record of the physical funds exchange.

Central to the integrity of the transaction is the reconciliation module 516. This component checks whether the transaction has been completed to satisfaction and all associated data is valid. If the module determines that the transaction is complete and all criteria are met, it proceeds with finalizing the transaction, updating the holding accounts 514 and the respective user accounts 510 and 512 to reflect the new balance of physical funds. In the event of discrepancies or incomplete transactions, the reconciliation module 516 may halt the process and signal for further review or action to resolve any outstanding issues. Through this intricate process, the transaction completion and reconciliation process 500 ensures that each mobile exchange of physical funds is conducted with precision and security, utilizing decentralized non-fungible token identification to protect the interests of all parties involved and maintain a seamless transaction flow.

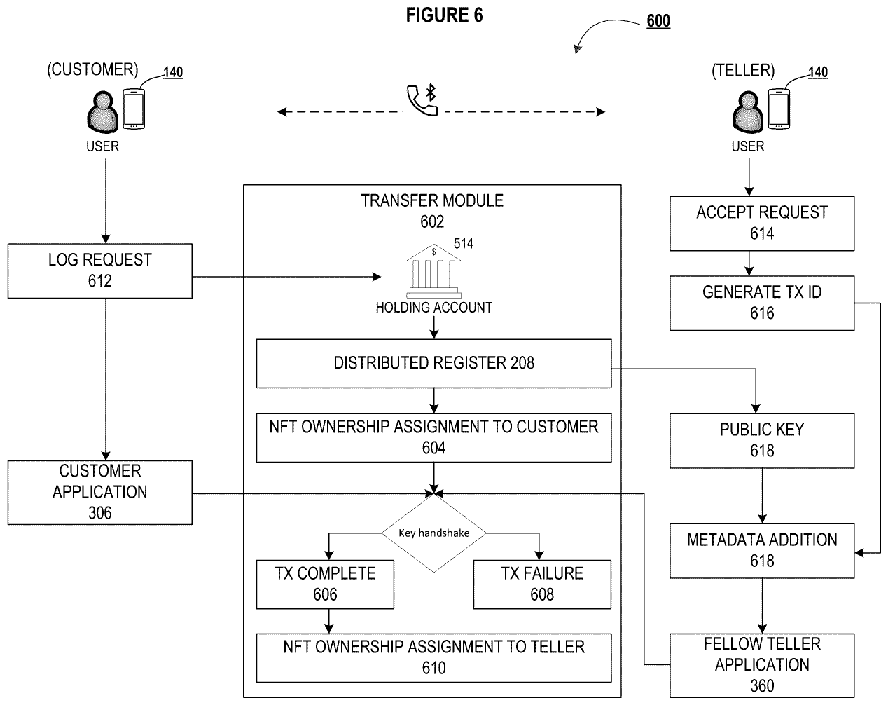

FIG. 6 illustrates components of an exemplary NFT generation process 600 for orchestration of mobile exchange utilizing decentralized non-fungible token identification and secure near-field communication, in accordance with an embodiment of the disclosure. This process facilitates the generation and assignment of ownership of NFTs which represent the physical funds involved in the transaction between the customer and teller users.

In some embodiments, a user 140, acting as the customer, initiates the process by logging a request 612 via the customer application 306. This request signifies the customer's intent to transact a certain amount of physical funds and triggers the NFT generation process. The customer application 306 is configured to interface with a distributed ledger network, sending transaction details through a secured API that employs cryptographic techniques such as hashing and digital signatures to ensure data integrity and security. Concurrently, another user 140, acting as the teller, receives the request through the fellow teller application 360 and accepts the request 614, indicating their willingness to provide the physical funds. The acceptance triggers an event in the teller application 360, which communicates with the distributed ledger to register the intent to transact, utilizing smart contracts to formalize the acceptance process.

Following the acceptance, the teller application 360 proceeds to generate a transaction identification number (“transaction ID”) 616, which uniquely identifies the transaction in the system. This transaction ID 616 is generated using a combination of timestamp, the teller's and customer's unique identifiers, and a random nonce to ensure uniqueness. One of ordinary skill in the art will appreciate that the transaction ID is critical for tracking and validating the exchange of funds and the corresponding NFT. It is understood that the system logs this transaction ID 616 along with the transaction details into a distributed ledger transaction, awaiting network confirmation to ensure immutability. The teller application also handles the public key 618, which is used to secure the communication and transaction between the customer and teller. The public key 618 is part of a public-private key pair generated by the teller, ensuring that all communications are encrypted and can only be decrypted by the corresponding private key held securely by the teller. Additionally, metadata addition 618 is performed by the teller application to encapsulate details such as the amount, time, and conditions of the transaction within the NFT. In some embodiments, this metadata is structured in a JSON format and embedded into the smart contract governing the NFT, which is then published to the distributed ledger, providing a tamper-proof record of transaction conditions.

On the customer's side, the transfer module 602 manages the transfer of funds into the holding account 514, a secure, temporary location where funds are held during the transaction. This module interfaces with backend entity APIs to facilitate the transfer of funds, employing secure protocols to maintain confidentiality and integrity of the financial data, or the like. The distributed register 208 then records the NFT ownership assignment to the customer 604, marking the customer's temporary ownership of the NFT until the transaction is completed. The assignment is recorded on the distributed ledger, using smart contract functionality to automate the change of ownership based on transaction completion criteria. Once the transaction is confirmed as complete by the customer through the transaction complete indicator 606, the NFT ownership is transferred from the customer to the teller, as indicated by NFT ownership assignment to teller 610. This final transfer is also managed by a smart contract, which executes upon confirmation from both parties, finalizing the ownership transfer on the distributed ledger. If the transaction fails for any reason, a transaction failure indicator 608 triggers appropriate remedial actions. Failure-handling mechanisms include smart contract functions designed to revert transaction changes and notify both parties of the failure, ensuring transparency and allowing for resolution. This NFT generation process ensures the integrity and traceability of each transaction, utilizing the distributed register 208 for a secure and immutable record of ownership and transfer of NFTs, representing the exchange of physical funds. The use of NFC and secure public keys further enhances the safety and reliability of the mobile exchange system.

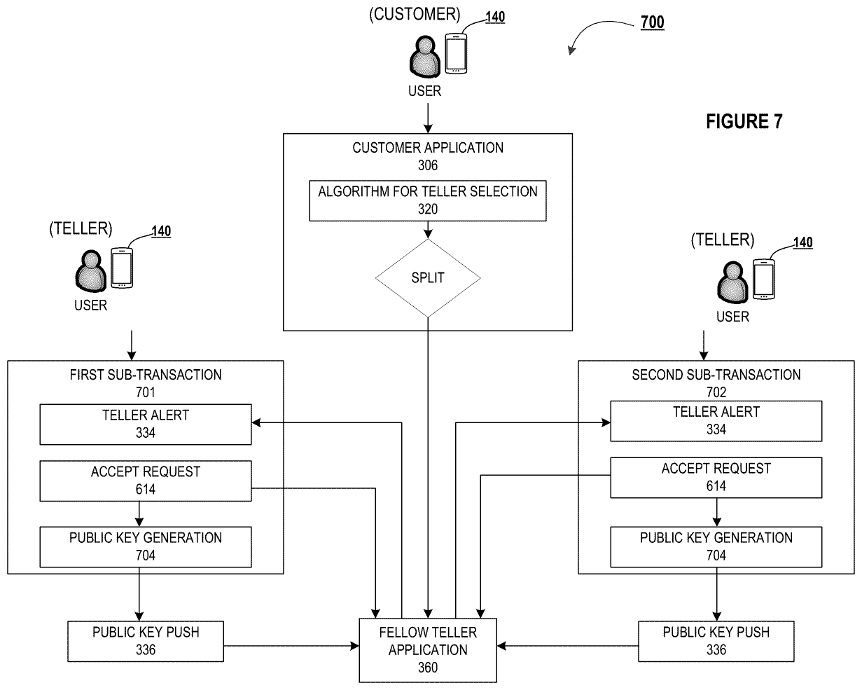

FIG. 7 illustrates components of an exemplary dual teller process 700 for orchestration of mobile exchange utilizing decentralized non-fungible token identification and secure near-field communication, in accordance with an embodiment of the disclosure. This process outlines a scenario in which a customer engages with two tellers to complete a transaction, particularly useful for larger transactions requiring multiple sources of physical funds.

At the core of the process is the customer application 306, which interfaces with the user 140, acting as the customer. The application 306 utilizes an algorithm for teller selection 320 to determine the most appropriate tellers based on factors such as location, fund availability, and transaction size. When a transaction exceeds a predefined threshold and necessitates splitting, the ‘SPLIT’ decision point indicates the process will involve more than one teller. For the first sub-transaction 701, a teller alert 334 is generated by the customer application 306 and sent to the first teller 140. Upon receiving the alert, the first teller uses their fellow teller application 360 to accept the request 614. Following this, a secure public key generation 704 takes place, ensuring that communication and transaction authorization between the customer and the teller are encrypted and secure. The teller then completes their part of the transaction by pushing their public key 336 back to the customer application 306, signaling readiness to proceed with their portion of the physical fund exchange.

Simultaneously, a parallel process is initiated for the second sub-transaction 702 involving another teller. The customer application 306 generates another teller alert 334, which follows a similar procedure. The second teller 140 receives the alert, accepts the request 614 through their fellow teller application 360, and engages in public key generation 704. This teller also sends a public key push 336 to indicate they are ready to complete their segment of the transaction. By engaging multiple tellers in the transaction, the dual teller process 700 provides a scalable and flexible approach to handling various transaction sizes, ensuring that the customer's needs are met even when a single teller cannot satisfy the entire request. This method amplifies the robustness and adaptability of the mobile exchange system by utilizing decentralized non-fungible token identification and NFC technology for secure, multiparty exchanges.

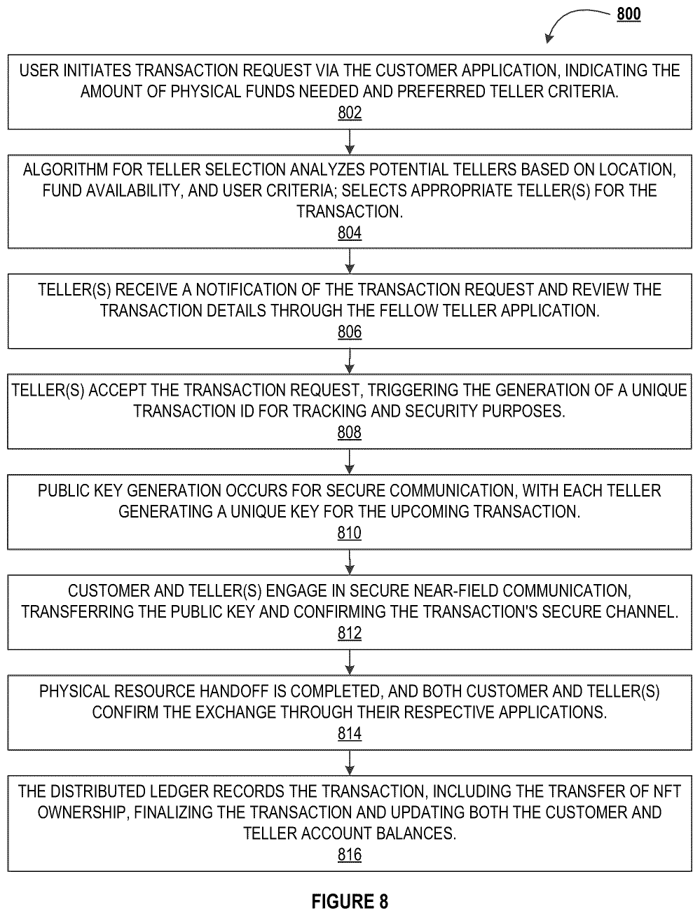

FIG. 8 illustrates a process flow 800 for orchestration of mobile exchange utilizing decentralized non-fungible token identification and secure near-field communication, in accordance with an embodiment of the disclosure. In some embodiments, as shown in block 802, the process begins whereby a user initiates a transaction request via the customer application, indicating the amount of physical funds needed and preferred teller criteria. The user's request includes specific parameters such as the desired denomination of physical funds, the urgency of the transaction, and any preferences for teller proximity or rating, ensuring a tailored response from the system to match their needs. In some embodiments, this initiation is facilitated through a user interface on the application that collects these inputs via form fields and dropdown menus, which are then serialized into a JSON object and transmitted to the server for processing.

In block 804, the algorithm for teller selection activates, sifting through the teller database to locate suitable candidates for the transaction. In some embodiments, the system uses a matching algorithm, possibly incorporating machine learning techniques to improve selection efficiency over time, that evaluates potential tellers based on a weighted scoring system as indicated in the discussion of FIG. 3. This step involves analyzing the tellers' locations relative to the user, the availability of the requested amount of physical funds in teller accounts, and the operational hours during which tellers are available to complete transactions. In some embodiments, geo-location APIs and a database query are used to pull relevant data, which is then processed by the algorithm to determine the best match based on proximity and availability. The algorithm prioritizes tellers based on the user's predefined criteria and the system's real-time assessment of the most efficient match.

Once potential tellers are identified, block 806 depicts the teller(s) receiving a notification alert through the fellow teller application. This notification is sent via push notification services integrated into the application, such as Firebase Cloud Messaging for Android or Apple Push Notification Service for iOS, providing real-time alerts to the tellers, or the like. This alert outlines the details of the transaction request and prompts tellers to review the specifics of the proposed exchange. Tellers are given the opportunity to assess the feasibility of meeting the transaction requirements before proceeding, ensuring informed consent for the exchange.

Block 808 illustrates the acceptance stage, where teller(s) agree to the transaction terms and thereby trigger the generation of a unique transaction ID by the system. This transaction ID is generated through a cryptographic hash function, ensuring it is unique and secure. It is understood that the transaction ID serves as a digital handshake, establishing a secure and trackable reference for the impending transaction. The transaction ID, along with the transaction terms, is then recorded in a transaction ledger stored on the server. It is understood that the transaction ID an essential part of the transaction ledger, creating a point of reference for future validation and reconciliation. The transaction's security is further bolstered in block 810 through the generation of public keys by the teller(s). In some embodiments, these keys are generated using asymmetric encryption algorithms, such as RSA or ECC, which are well-suited for secure digital communications. These keys are cryptographic assurances, securing the communication channel for the transaction and ensuring that the exchange of physical funds will be protected against unauthorized access or malfeasant activities.

In block 812, the customer and teller(s) engage in a secure exchange using near-field communication, with the public keys providing encrypted connectivity for the transaction. It is understood that the NFC technology allows devices to communicate within a short range, typically less than 10 cm, ensuring that the transaction remains confined to the proximity of the devices involved. During this phase, both parties confirm the transaction details, and the system verifies the integrity of the communication, setting the stage for the physical handoff of funds. In some embodiments, this confirmation process involves digital signatures, where each party signs the agreed transaction details to be verified by the other party's device, or the like.

The actual exchange of physical funds is completed in block 814, where the physical resource handoff takes place. Sensors in the devices can detect the completion of the fund transfer, confirming that the physical tokens have been exchanged, or the like. In preferred embodiments, this confirmation process involves digital signatures, where each party signs the agreed transaction details to be verified by the other party's device. Following the secure exchange, both the customer and teller(s) confirm the completion of the transaction through their applications, signaling to the system that the physical funds have successfully changed hands.

Finally, block 816 concludes the process with the distributed ledger recording the transaction details. This involves a smart contract on the distributed ledger that updates the ownership status of the NFT representing the physical funds, ensuring that all changes are immutable and traceable. This recording includes updating the non-fungible token ownership to reflect the new state of affairs, finalizing the transaction, and reconciling the account balances for both the customer and teller(s). This step ensures that the integrity of the transaction is maintained and that both parties have a verifiable record of the transaction within the decentralized ledger system. As such, the technology of the present invention not only provides a secure and decentralized framework for these transactions but also facilitates automatic execution and reconciliation.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for orchestration of mobile exchange utilizing decentralized non-fungible token identification and secure near-field communication, the system comprising:
a processing device;
a non-transitory storage device containing instructions when executed by the processing device, causes the processing device to perform the steps of:
receiving a transaction request for a transaction via a customer application, the transaction request comprising an amount of physical funds needed and one or more criteria for selecting a teller;
activating a teller selection algorithm to sort one or more teller options retrieved from a teller database based on the transaction request to identify one or more suitable tellers;
generating and transmitting a notification to the one or more suitable tellers via a teller application, wherein the notification includes a subset of transaction details;
receiving an acceptance from at least one of the one or more suitable tellers, triggering a generation of a unique transaction identification (ID) and a public key;
facilitating a secure exchange of physical funds using near-field communication based on the generated public key; and
recording transaction details on a distributed ledger to finalize the transaction and update non-fungible token ownership.

2. The system of claim 1, further comprising the step of encrypting the transaction details using the public key before transmitting the details to the distributed ledger.

3. The system of claim 1, wherein exchange of physical funds is confirmed via both the customer application and the teller application.

4. The system of claim 1, wherein the teller selection algorithm further comprises assigning weights to each of the one or more criteria for selecting a teller, the criteria including at least one of proximity to a customer, an availability of the requested amount of physical funds, and operational hours of the tellers.

5. The system of claim 1, wherein the transaction request further includes a preferred transaction time, and the teller selection algorithm prioritizes tellers who are available during the specified transaction time.

6. The system of claim 1, further comprising a step of validating the digital identity of the teller and a customer using digital signatures prior to exchange of physical funds.

7. The system of claim 1, wherein the generated public key is part of a public and private key pair, and a private key is used to decrypt received communications during the transaction process.

8. A computer program product for orchestration of mobile exchange utilizing decentralized non-fungible token identification and secure near-field communication, the computer program product comprising a non-transitory computer-readable medium comprising code causing an apparatus to perform the steps of:
receiving a transaction request for a transaction via a customer application, the transaction request comprising an amount of physical funds needed and one or more criteria for selecting a teller;
activating a teller selection algorithm to sort one or more teller options retrieved from a teller database based on the transaction request to identify one or more suitable tellers;
generating and transmitting a notification to the one or more suitable tellers via a teller application, wherein the notification includes a subset of transaction details;
receiving an acceptance from at least one of the one or more suitable tellers, triggering a generation of a unique transaction identification (ID) and a public key;
facilitating a secure exchange of physical funds using near-field communication based on the generated public key; and
recording transaction details on a distributed ledger to finalize the transaction and update non-fungible token ownership.

9. The computer program product of claim 8, further comprising the step of encrypting the transaction details using the public key before transmitting the details to the distributed ledger.

10. The computer program product of claim 8, wherein exchange of physical funds is confirmed via both the customer application and the teller application.

11. The computer program product of claim 8, wherein the teller selection algorithm further comprises assigning weights to each of the one or more criteria for selecting a teller, the criteria including at least one of proximity to a customer, an availability of the requested amount of physical funds, and operational hours of the tellers.

12. The computer program product of claim 8, wherein the transaction request further includes a preferred transaction time, and the teller selection algorithm prioritizes tellers who are available during the specified transaction time.

13. The computer program product of claim 8, further comprising a step of validating the digital identity of the teller and a customer using digital signatures prior to exchange of physical funds.

14. The computer program product of claim 8, wherein the generated public key is part of a public and private key pair, and a private key is used to decrypt received communications during the transaction process.

15. A method for orchestration of mobile exchange utilizing decentralized non-fungible token identification and secure near-field communication, the method comprising:
receiving a transaction request for a transaction via a customer application, the transaction request comprising an amount of physical funds needed and one or more criteria for selecting a teller;
activating a teller selection algorithm to sort one or more teller options retrieved from a teller database based on the transaction request to identify one or more suitable tellers;
generating and transmitting a notification to the one or more suitable tellers via a teller application, wherein the notification includes a subset of transaction details;
receiving an acceptance from at least one of the one or more suitable tellers, triggering a generation of a unique transaction identification (ID) and a public key;
facilitating a secure exchange of physical funds using near-field communication based on the generated public key; and
recording transaction details on a distributed ledger to finalize the transaction and update non-fungible token ownership.

16. The method of claim 15, further comprising the step of encrypting the transaction details using the public key before transmitting the details to the distributed ledger.

17. The method of claim 15, wherein exchange of physical funds is confirmed via both the customer application and the teller application.

18. The method of claim 15, wherein the teller selection algorithm further comprises assigning weights to each of the one or more criteria for selecting a teller, the criteria including at least one of proximity to a customer, an availability of the requested amount of physical funds, and operational hours of the tellers.

19. The method of claim 15, wherein the transaction request further includes a preferred transaction time, and the teller selection algorithm prioritizes tellers who are available during the specified transaction time.

20. The method of claim 15, wherein the generated public key is part of a public and private key pair, and a private key is used to decrypt received communications during the transaction process.
